(19) United States
(12) Patent Application Publication
(10) Pub. No.: US 2012/0293016 A1
(43) Pub. Date: Nov. 22, 2012

(54) PROTECTIVE DEVICE FOR GALVANIC CELLS

(75) Inventors: Tim Schaefer, Harztor (DE); Andreas Gutsch, Luedinghausen (DE)

(73) Assignee: Li-Tec Battery GmbH, Kamenz (DE)

(21) Appl. No.: 13/393,951

(22) PCT Filed: Aug. 30, 2010
(86) PCT No.: PCT/EP10/05319

§ 371 Date: Aug. 2, 2012

(30) Foreign Application Priority Data
Sep. 4, 2009 (DE) 102009040146.6

(51) Int. Cl. H01H 35/00

(52) U.S. Cl. 307/117

(57) ABSTRACT

A protective device for galvanic cells (201, 202, 301, 302) which are interconnected via contact elements (205, 207, 209, 212, 405, 409, 406, 407, 506, 507, 509, 606, 607, 706, 707, 709, 805, 806, 807, 809) that are suitably connected to pole connections (203, 204, 503, 504) of said cells to give a battery can be associated with individual cells of a battery. The protective device has an activation device (1008, 1108, 1208, 1011, 1111) for activation. When the protective device is activated, the protective device bridges the cell associated therewith by changing the interconnection and thus removes it from the electrical functioning of the battery assembly. In the activation device, preferably an electroconductive or insulating component made of a shape memory material brings about the change of the interconnection by changing the shape of said component as soon as and/or as long as the temperature of said component lies outside a defined temperature range.

The invention relates to a protective apparatus for galvanic cells, a galvanic cell with a protective apparatus of this type and a battery made up of such galvanic cells.

Batteries consist of individual cells connected in series and/or in parallel, which are often located in a common housing with the associated electronics and cooling. In automotive technology, batteries of this type, in particular high-voltage batteries are used inter alia as traction battery for electric vehicles and as energy buffer storage unit for hybrid vehicles. Cells of this type can be damaged, for example, by overcharging, by short circuit or due to other causes, or otherwise disrupted in terms of their intended function.

For example, lithium-ion batteries are known, which interrupt the circuit when the cells are overloaded or short circuited. It is known for example, in the case of overheating of a cell of this type, to break open the housing thereof at a targetedly weakened point, for example with the aid of a rupture disc, under the action of the simultaneously increased internal pressure of the cell, and in this case, to separate the electrical contact of the electrode winding to the battery poles. Known solutions of this type are in some cases connected with the disadvantage that, due to the cell-side disconnection of the circuit, the cells connected in series to the defective cell can likewise no longer emit current. Particularly in the case of electric vehicles, this can lead to total failure (“dead vehicle”). In the case of hybrid vehicles, depending on the system structure, the restarting of the internal combustion engine may for example no longer be possible.

To prevent these disadvantages, apparatuses have been suggested, in which a defective cell is removed from the electric series connection and is bridged at the same time. In the case of such known solutions, the device for cell-side disconnection of the circuit and for bridging the defective cell often obtains its actuation energy from the pressure increase in the interior of the cell. These known apparatuses are therefore only effective if the cell is already irreversibly damaged. In such cases, the cell contents, for example a partially evaporated electrolyte, can escape, which can cause further short circuits due to its electrical conductivity. Repairing the battery is often no longer possible or worthwhile in such cases, because the interior of the battery is attacked within a short time due to the corrosive action of the electrolyte.

The present invention is based on the object of specifying an effective protective apparatus for galvanic cells and, if possible, avoiding the problems connected with the known solutions.

This object is achieved by means of a protective apparatus for galvanic cells according to claim 1. It is further achieved by means of an article according to one of the further independent claims.

The invention provides a protective apparatus for galvanic cells which are interconnected to form a battery by means of contact elements connected to pole connections of the cells in a suitable manner. The protective apparatus according to the invention is characterised in that it has an activation apparatus for activating the protective apparatus. This protective apparatus according to the invention bridges a cell assigned to it by means of a change of the interconnection in the case of an activation of the protective apparatus and thus electrically removes this cell from the battery assembly.

Terms used in connection with the description of the present invention are defined and explained in the following.

A galvanic cell in the sense of the present invention should be understood as meaning an electrical or electrochemical cell suitable for constructing a battery, in particular a primary cell or a secondary cell. Cells of this type are also designated as battery cells, cells or individual cells in the following. A battery is to be understood as meaning an interconnection of cells of this type in series and/or in parallel.

An interconnection of galvanic cells is to be understood in connection with the present invention as meaning any technically sensible combination of series and/or parallel connections of cells of this type. It is produced by means of suitable connection of the pole connections of such galvanic cells with the aid of contact elements, particularly with the aid of contact plates, contact rails, insulators, etc.

In the present context, an activation apparatus is to be understood as meaning any apparatus for activating the protective apparatus according to the invention, which puts a protective apparatus according to the invention into a position to bridge individual cells of a battery in a targeted manner and thus to electrically remove the same from the battery assembly. The expression electrically remove means that although the respective cell spatially remains at its position in the battery assembly, this cell is removed from the electrical series and/or parallel connection of a plurality of cells, which constitutes the battery, by means of the bridging of certain contacts.

Energy is required to activate the protective apparatus with the aid of the activation apparatus, for example because contact elements must be moved to this end. According to the invention, this energy is fed to the activation apparatus from outside or provided by means of an energy store which is a constituent of the protective apparatus or the activation apparatus. Here, one may be concerned with energy stores of any possible type, particularly mechanical energy stores. In the case of the feeding of the energy required for activation from outside, any type of suitable apparatus comes into consideration, particularly electromagnetic converters such as for example electromagnetic switches (relays, etc.), which are operated with the aid of energy which is fed from outside, that is to say for example is withdrawn from the battery assembly, the remaining cells of which remain regularly functional.

Advantageous developments of the invention form the subject of subclaims.

In the following, the invention is explained in more detail on the basis of preferred exemplary embodiments and with the aid of figures. In the figures

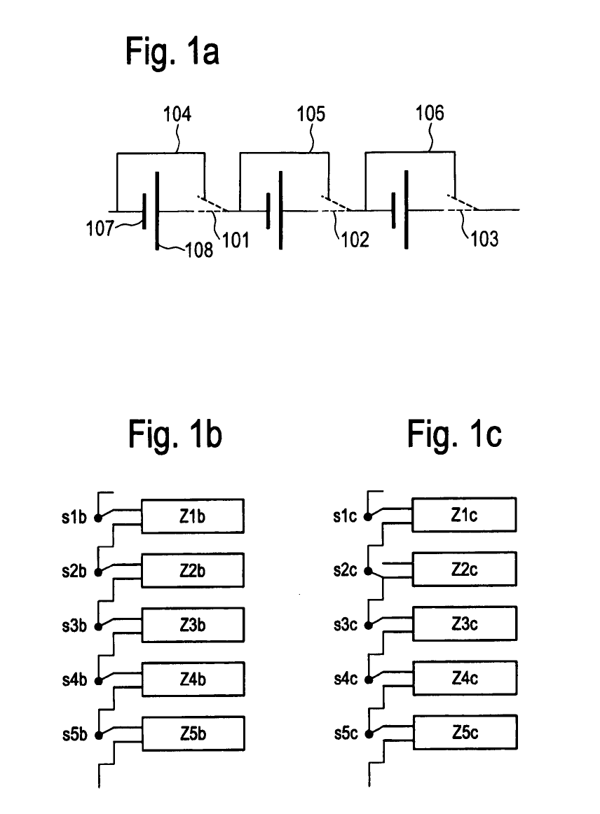

FIG. 1a shows a circuit diagram of a series connection of battery cells which in each case have an actively controllable cell-side apparatus for removing and for bridging cells electrically connected in series according to a preferred embodiment of the invention;

FIG. 1b shows an interconnection of battery cells with the switches of a protective apparatus, in which all switches are in a position which effects a series connection of all of the battery cells;

FIG. 1c shows an interconnection of battery cells, in which one switch is in a position which effects a bridging of a battery cell and thus the removal thereof from the battery assembly;

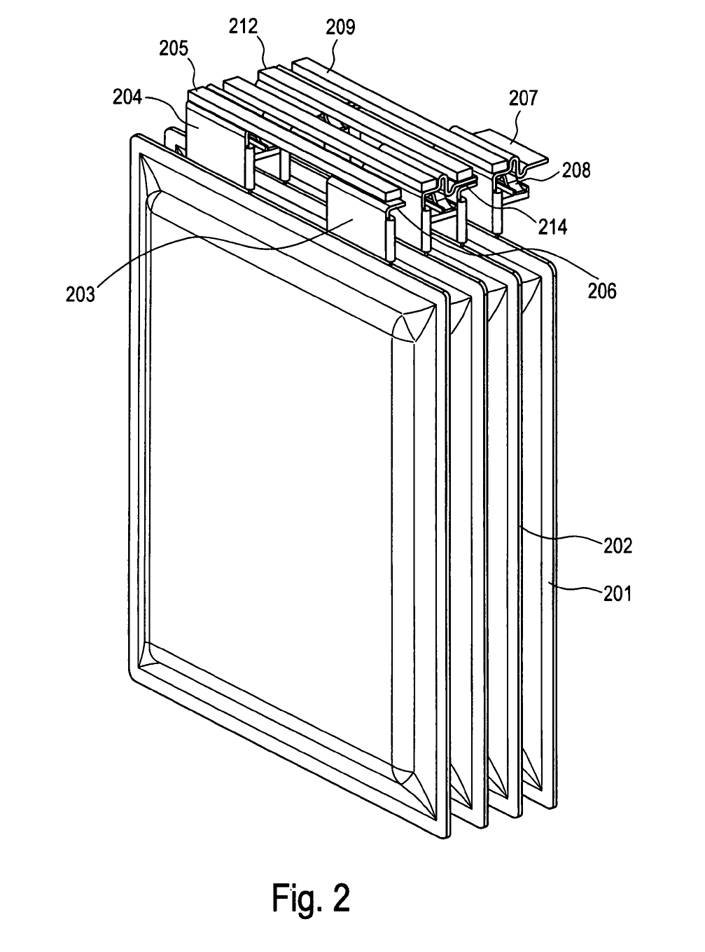

FIG. 2: shows an interconnection of battery cells with protective apparatuses according to a preferred embodiment of the invention;

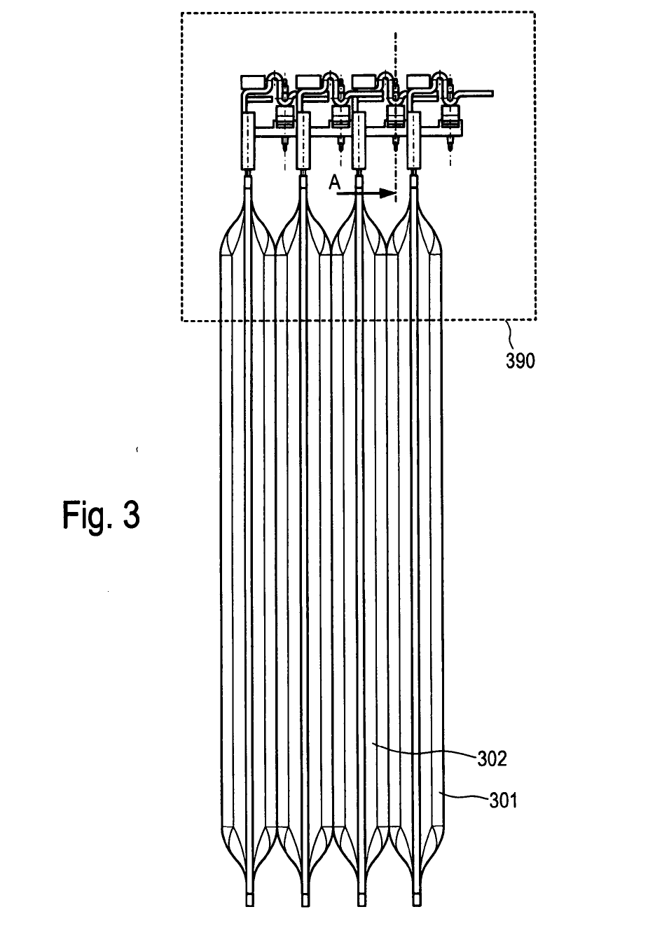

FIG. 3: shows a side view of a cell block with protective apparatuses according to a preferred embodiment of the present invention;

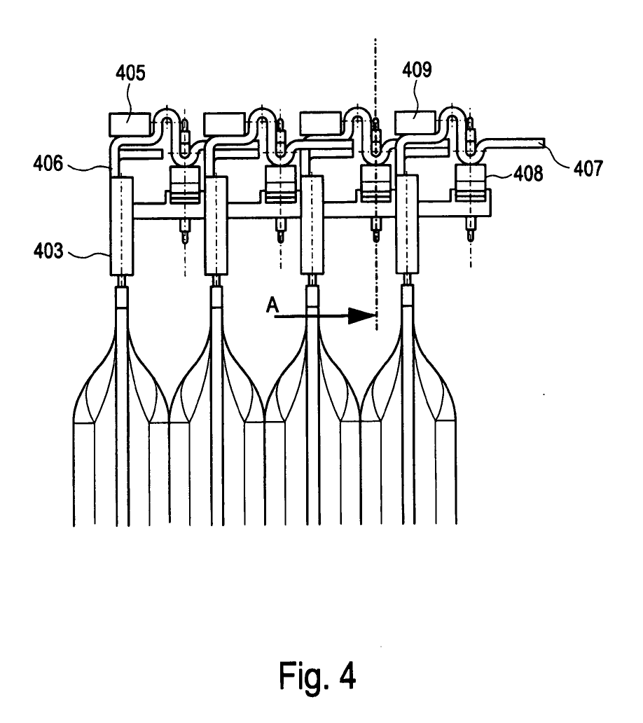

FIG. 4 shows an enlarged illustration of the upper part of the cell block illustrated in FIG. 3 with a protective apparatus according to a preferred embodiment of the present invention;

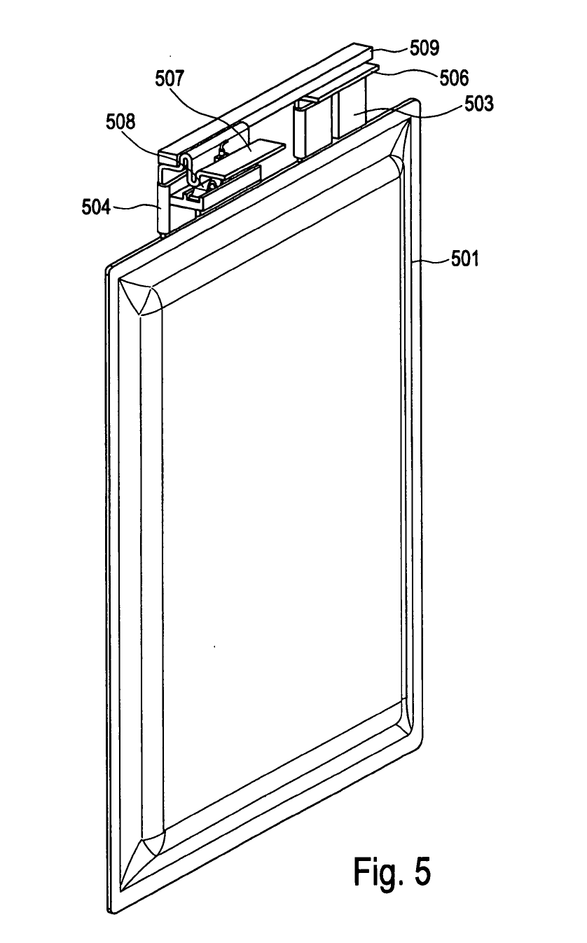

FIG. 5 shows the view of a cell with a protective apparatus according to a preferred exemplary embodiment of the present invention;

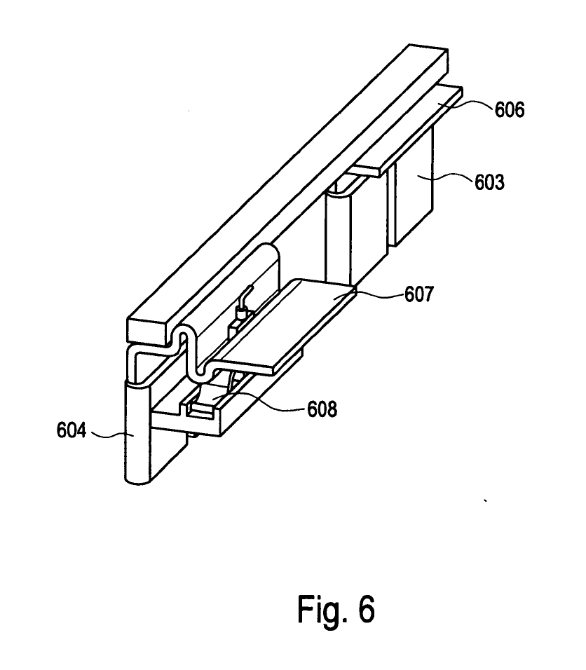

FIG. 6 shows a detailed view of a protective apparatus according to a preferred embodiment of the invention;

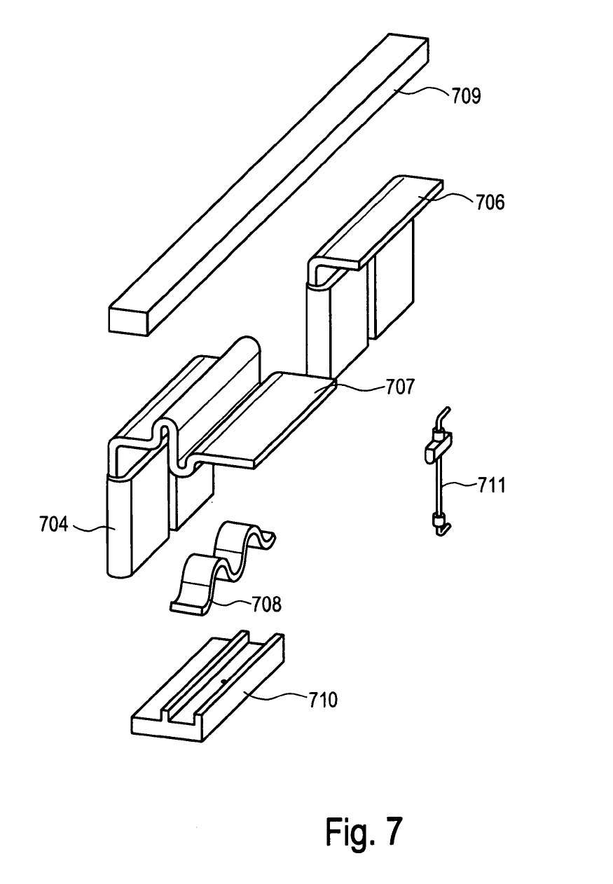

FIG. 7 shows an exploded illustration of the embodiment shown in FIG. 6;

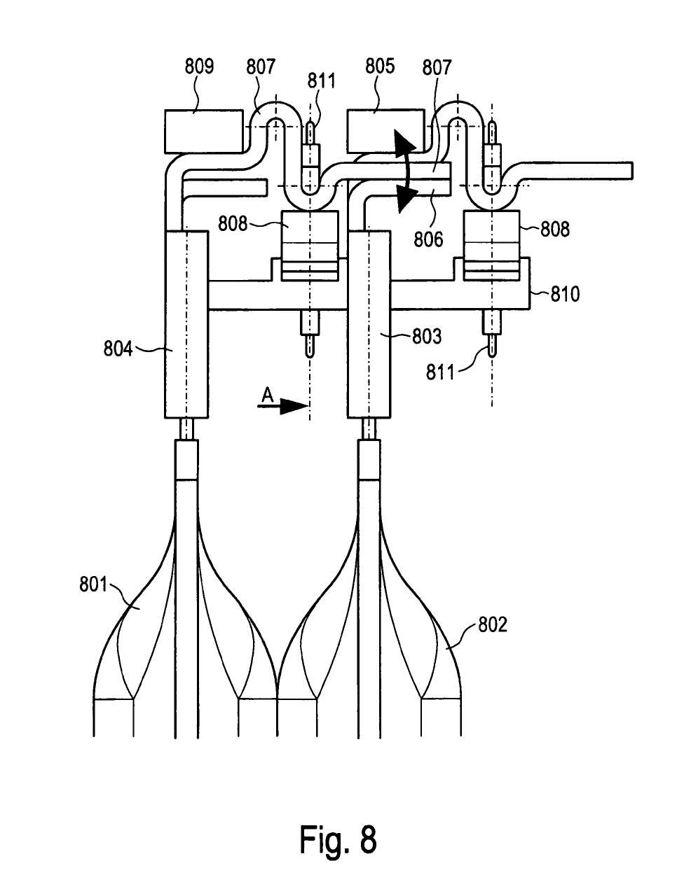

FIG. 8 shows a side view of a protective apparatus according to a preferred embodiment of the invention in the inactive state (normal operation);

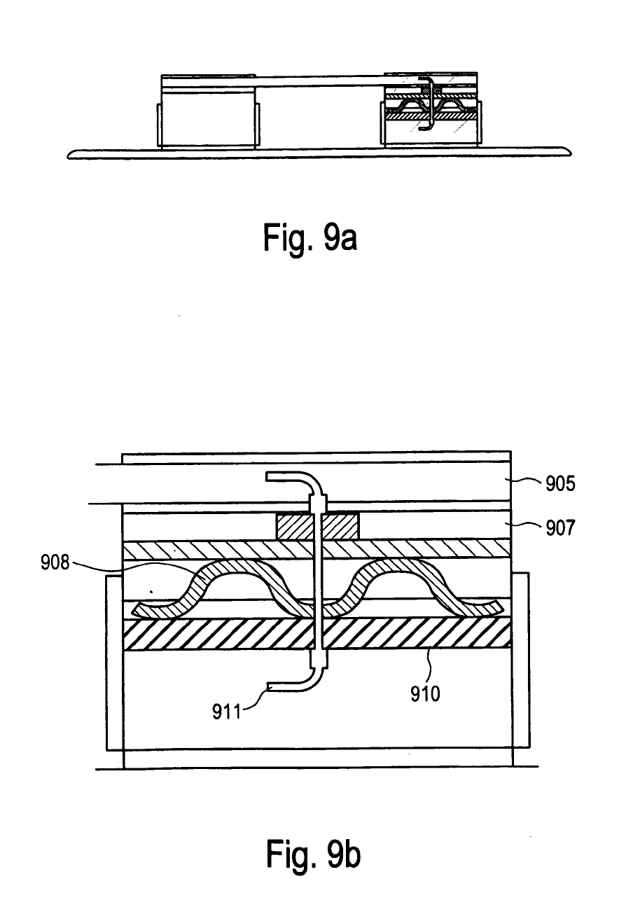

FIG. 9a shows a sectional image of a protective apparatus according to a preferred embodiment of the invention;

FIG. 9b shows an enlargement of the right part of the embodiment shown in FIG. 9a in the inactive state (normal operation);

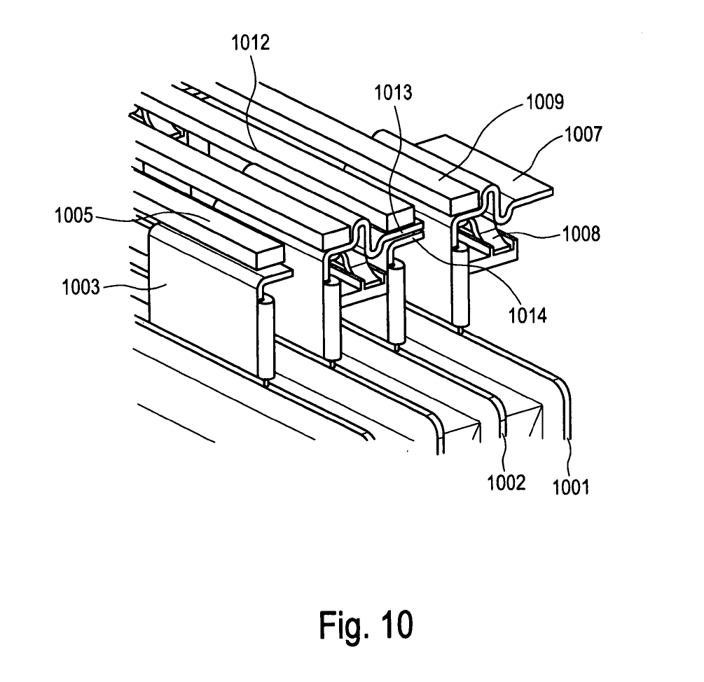

FIG. 10 shows the view of a cell block with activated protective apparatus according to a preferred embodiment of the present invention;

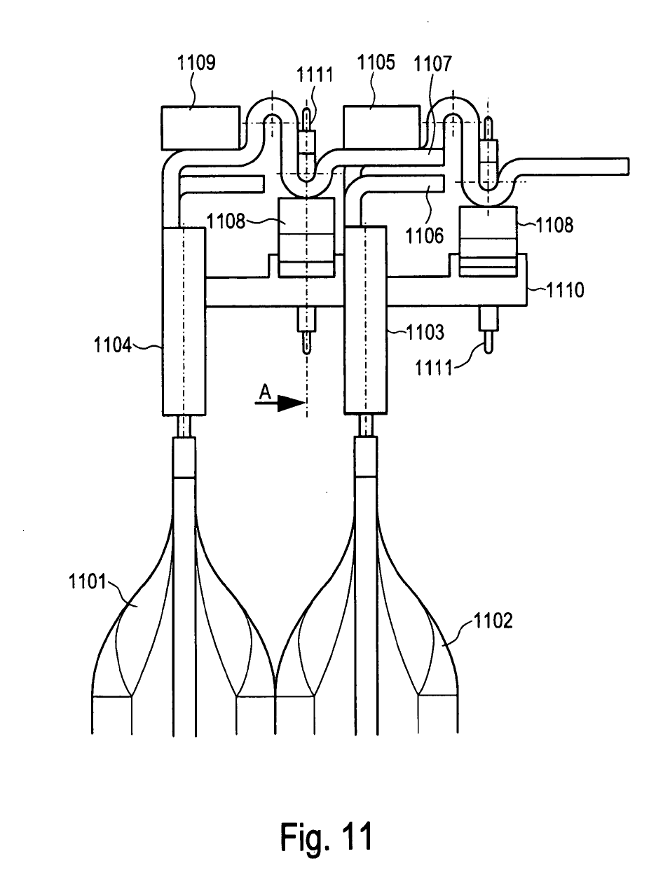

FIG. 11 shows a side view of an activated protective apparatus according to a preferred embodiment of the present invention;

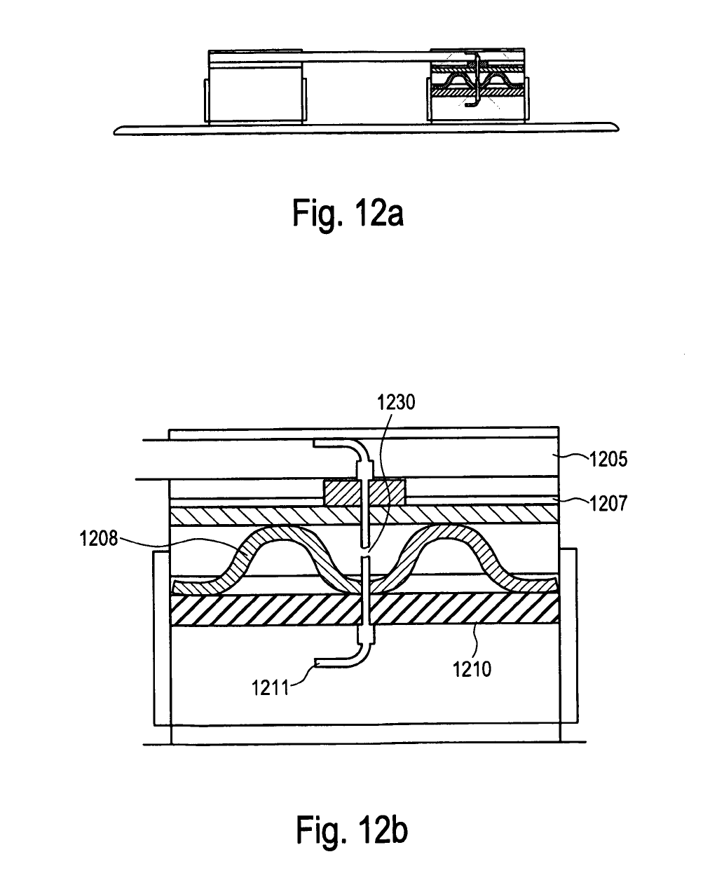

FIG. 12a shows a sectional image of a protective apparatus according to a preferred embodiment of the invention in the case of an activated protective apparatus; and

FIG. 12b shows an enlarged illustration of the right part of the embodiment of an activated protective apparatus shown in FIG. 12a.

As illustrated in FIG. 1a, the fundamental mode of action of a protective apparatus according to the invention is to remove a defective cell from an interconnection of a plurality of cells in a targeted manner by means of bridging. To this end, bridges 104, 105, 106 are provided, which, in the case of activation of one of the switches 101, 102, 103, connect an electrode 107 to the similar electrode of an adjacent cell. In the inactive state of the protective apparatus, by contrast, the electrode 108 is connected to the dissimilar electrode of the adjacent cell. Similarly, FIGS. 1b and 1c show the fundamental mode of action of the protective apparatus according to the invention. As all of the switches S1b, S2b, . . . , S5b in FIG. 1b are in a correspondingly similar position, a series connection of cells Z1b, Z2b, Z5b is present in FIG. 1b. In FIG. 1c, the switch S2c is in the activated position, as a result of which, the cell Z2c is removed from the interconnection.

As illustrated in FIG. 2, the interconnection of battery cells takes place with the aid of contact elements. The contact rails 205, 209 and 212 illustrated in FIG. 2 are examples of such contact elements. The electrodes (diverters) 203 and 204 are connected or not connected to these contact elements in a suitable manner. The protective apparatus according to the invention is preferably arranged between the strip-shaped poles (“diverters”) of two adjacent cells in each case. The actuation energy for the activation of the protective apparatus is for example stored in a wave spring 208, which is held in its initial position by a fuse wire 711, 811, 911 shown in FIGS. 7 and 9. At the onset of malfunction, this fuse wire fuses by means of a current pulse and the wave spring 208, 708, 908 shown in FIGS. 2, 7 and 9 lifts the contact rail hitherto undertaking the electrical series connection and presses the same against a second contact rail, which electrically bypasses the defective cell.

According to a preferred embodiment of the present invention, the protective apparatus according to the invention is equipped with an energy store which stores and in the case of an activation provides the energy required to change the interconnection. This may be a mechanical energy store or other energy stores, chemical or electrical energy stores for example. A simply structured energy store 208, 408, 508, 608, 708, 808, 908, 1008, 1008, 1108, 1208 is shown in FIGS. 2, 4, 5, 6, 7, 8, 9, 10, 11 and 12. A wave spring 208, 408, 508, 608, 708, 808, 908, 1008, 1008, 1108, 1208 is held from below by means of a bearing 210, 310, 910, 1010, 1110. A fuse wire 711, 811, 911, 1111 holds this wave spring in its initial position and initial shape, that is to say in the tensioned state. If the wire fuses, the wave spring lifts the contact plate 207, 407, 507, 607, 707, 807, 907, 1007, 1207 and presses it against the contact rail 1105, 1205. The contact to the contact plate 1106 is interrupted. Thus, the bridging of the cell has taken place.

The protective apparatus is preferably located in a housing which is not illustrated in the figures. This housing is preferably closed in an airtight manner to prevent corrosion and, if required, filled with an inert protective gas.

The protective apparatus according to the invention can preferably be controlled actively and individually for each cell and thus individually remove the respective damaged cell from the circuit and bridge the same. If, for example the battery electronics detect the onset of malfunction by means of the monitoring of the cell voltage and/or the cell temperature, the apparatus can be triggered preventatively. The battery remains operational with only a slightly reduced voltage level.

The solutions according to the invention, in which the energy for activation is not withdrawn from a process which is associated with the malfunction or with the destruction of the affected cell which is to be bridged, but rather in which the energy for activation is supplied from outside of the protective apparatus or is withdrawn from an energy store which is preferably a constituent of the protective apparatus or the activating apparatus, are connected with the advantage that a cell affected by a malfunction can already be electrically removed from the battery assembly at an earlier time, at which the destruction of the cell has not yet begun or even is so far advanced that the energy required for activating the protective apparatus could be withdrawn from the destruction process. In many cases, destruction of the cell becomes preventable as a result. Under favourable conditions, it is possible that a bridged cell recovers after a certain time and can again be accommodated in the battery assembly.

Assuming that the activation of the protective apparatus takes place early enough, the cell to be bridged can even also supply the energy for activating its protective apparatus. It can therefore act as an energy store of the protective apparatus before it is electrically removed from the battery assembly by means of bridging.

Depending on the present application, a protective apparatus according to the invention is equipped with an activation apparatus, which can be activated by means of a signal which is generated within or outside of the protective apparatus. Which of these two options is to be preferred will depend primarily on the nature of the activating event. It is possible for example, that battery electronics monitor the cell voltage of individual cells and pass on the measurement results to a central control unit outside of the battery, which then for its part generates the signal for activating the protective apparatus of that cell or those cells and forwards the same to the relevant protective apparatus or protective apparatuses, which are assigned to the cells to be bridged.

A particularly advantageous embodiment of a protective apparatus according to the invention provides an activation apparatus which can be activated by means of a signal which is generated by at least one sensor which measures at least one physical value which is indicative for the operating state of the battery cell which is assigned to the protective apparatus. Such sensors can for example be temperature sensors which are attached to each cell and constantly measure the temperature of the cell assigned to them. Here also, various options for analysing the measurement result are presented.

It is possible for example that a temperature sensor locally generates a signal for activating the protective apparatus of the cell, the temperature of which it continuously measures. It is also possible however, that a central control unit analyses the measurement results of these and/or other sensors, such as temperature and voltage sensors, together in order to generate a signal for activating the protective apparatuses of individual cells as a function of a plurality of measurement results with the aid of a special decision logic, which signal is then forwarded to the activation apparatuses of the protective apparatuses of these cells and there leads to the activation of the relevant protective apparatuses.

According to a likewise preferred embodiment of the present invention, a protective apparatus is provided, the activation apparatus of which can be deactivated in the case of the subsequent cessation of the prerequisites for its activation, whereupon this protective apparatus reverses the bridging of the cell assigned thereto, as a result of which this cell is reintegrated into the battery assembly. The activation apparatus of the protective apparatus according to the invention can preferably also be realised in such a manner that, for example following a cooling of the relevant cell, the same can again be connected to the battery assembly. The energy required for this can for example be removed from the now again functional cell itself or the other cells remaining in the battery assembly. In the case of this connection, the energy store for activating the protective apparatus can preferably also be recharged.

According to a likewise preferred embodiment of the present invention, a protective apparatus is provided, which is configured in such a manner that it can be arranged between the pole contacts of adjacent cells. FIGS. 3, 4, 8, 10 and 11 show illustrations of such exemplary embodiments of the present invention.

According to a likewise preferred embodiment of the present invention, a protective apparatus is provided with an activation apparatus, which comprises a fuse wire, which holds a wave spring, which serves as energy store, in a tensioned state, and which is activated by a current pulse which fuses the fuse wire, whereupon the wave spring is relaxed and provides the energy required to change the interconnection. This mechanical configuration of the energy store is to be produced—for example, compared to an external active control of the activation apparatus—particularly robustly with respect to disturbances and—due to eliminated signal lines—inexpensively.

Also advantageous is a protective apparatus according to the invention with a housing closed in an airtight manner. A protective apparatus according to the invention, the housing of which is filled with an inert protective gas, is particularly advantageous. Compared to a housing filled with ambient air, the corrosion protection with a suitable choice of the protective gas is often better.

FIG. 5 shows a battery cell 501 with a protective apparatus according to the invention. The electrodes 503 and 504 are connected to contact rails 509 by means of suitable contact plates 506 and 507. A wave spring 508 changes the position of the contact plate 507 when the protective apparatus of the cell 501 is activated.

FIG. 6 shows an enlarged illustration of a protective apparatus according to the invention with the electrodes 603, 604, the wave spring 608 and the contact plates 606 and 607. As FIG. 7 shows, the wave spring 708 is mounted on a bearing 710, which ensures that, in the case of fusing fuse wire 711, the relaxing wave spring cannot deflect downwards, for which reason, the contact plate 707 of the electrode 704 must push upwards in the case of an activation of the protective apparatus.

As can be seen in FIG. 8, the contact plate 707 or 807 makes contact with the contact plate 806 of the adjacent cell 802 before the activation. Following activation by means of the fusing of the fuse wire 811 it makes contact with the contact rail 805.

The side sectional illustrations of FIGS. 9a, 9b and 12a and 12b show the same embodiment of the protective apparatus according to the invention before and after the activation. The FIGS. 9a and 12a show the context for the sections illustrated in the FIGS. 9b and 12b.

According to a preferred embodiment of the invention, an activation apparatus is provided for the protective apparatus according to the invention, in which at least one component made up of a shape memory material changes the interconnection by means of a change in the shape of this component, as soon as and/or as long as the temperature of this component lies outside of a defined temperature range.

Various materials with shape memory are known. In the main, such materials are metallic alloys, so-called shape memory alloys or plastics with shape memory, which are also termed shape memory polymers. In the case of the shape memory alloys, the shape change is based on a temperature-dependent lattice transformation of two different crystal structures of a material. In this case, it imparts the high-temperature phase, which is termed austenite, and the low-temperature phase, which is also termed martensite, of the shape memory material. Both phases can blend into one another by means of a temperature change. In this context, one also speaks of a two-way effect. This structural transformation is at least approximately independent of the rate of temperature change. To initiate the desired phase change, the parameters of temperature and mechanical stress are often approximately equal, i.e. the transformation can be induced not only thermally but also often in a stress-induced manner.

Shape memory alloys can convey quite large forces without material fatigue in up to several hundred thousand movement cycles. Their specific working capacity, i.e. the ratio of work performed to the material volume exceeds the specific working capacity of many other so-called actuator materials by far. In the applications of shape memory alloys, a distinction is often made between the so-called one-way (memory) effect and the so-called two-way (memory) effect. In a one-way effect, a one-time shape change is to be observed during heating of a material sample previously pseudoplastically deformed in the martensitic state. This one-way effect allows only a one-time shape change. The renewed cooling causes no further shape change. For the use of shape memory alloys for actuator technology also, e.g. as a setting element, especially in connection with the present invention, it is often desirable, however, that the component can return to its martensitic “cold form” again.

There are basically two ways to bring about a shape reversion of the material:

a) The so-called external or extrinsic two-way effect.
In the case of the external two-way effect, the shape reversion occurs during cooling of a component by means of an externally acting force which forces the shape reversion. This can be realised e.g. by means of a spring which was tensioned during the heating of the shape memory material.
   b) The so-called intrinsic two-way effect
Other shape memory alloys execute the shape reversion, but without the action of external forces also. This process is also termed the intrinsic two-way effect. Shape memory alloys of this type can “remember” two shapes as it were—one at high and one at low temperature in each case. The component made from a shape memory material must have previously been “trained” by means of thermomechanical treatment cycles so that it assumes its defined shape again when cooling. Here, the formation of stress fields, which promote the formation of certain martensite variants during cooling, is effected in the material. The trained shape for the cold state is therefore in one sense merely a preferred shape of the martensite structure. The conversion of the shape can only take place in the case of the intrinsic two-way effect if no external forces act against it. Therefore, such a component is therefore not in a position during cooling to carry out work.

In the case of shape memory alloys, in addition to the usual elastic deformation, a reversible shape change caused by the action of an external force can often be observed. This “elastic” deformation may exceed the elasticity of conventional materials by up to twenty times. The cause of this material behaviour lies not in interatomic interaction, however, but rather in a phase transformation within the material. Here, under external stresses, the so-called cubic face centred austenite transforms into monoclinic martensite. Under mechanical relief, the martensite is transformed back into austenite. As the arrangement of atoms in the crystal structure is not changed here and therefore each atom retains its adjacent atom, one also speaks of a diffusionless phase transformation. This material property is also termed pseudoplastic behaviour. The material returns to its original shape when relieved due to its inner stress. Temperature changes are not required to this end.

Examples of shape memory alloys are alloys of nickel and titanium, of copper and zinc, of copper, zinc and aluminium, of copper, aluminium and nickel, and of iron, nickel and aluminium.

In addition to the metallic shape memory alloys, shape memory polymers form a second important group of shape memory materials. Shape memory polymers are plastics which have a so-called shape memory effect, which therefore appear to be able to “remember” their earlier external shape, despite an interim strong deformation. Shape memory polymers which became known early consisted of two components. The first was an elastic polymer, a type of “spring element”, the second a hardening wax that the “spring element” can lock in any desired shape. If one heats the shape memory polymer, then the wax becomes soft and can no longer counteract the force of the spring element. The shape memory polymer assumes its original shape.

As with the shape memory alloys, there are shape memory polymers which assume their original shape again when heated. This behaviour is known as the one-way memory effect, as in the case of the shape memory alloys.

More recently, polymers with a reversible shape memory effect have also become known, which are controlled not thermally but often optically. Examples for this include so-called butyl acrylates which crosslink at their side chains via cinnamic acid groups under ultraviolet light of a certain wavelength and dissolve the bond again when irradiated with a different wavelength. If one irradiates a component of this type on one side, then a shape change of this material results by means of the crosslinking initiating on one side. In the meantime, magnetically controllable shape memory polymers have also become known.

A preferred embodiment of the invention provides an electrically conductive component made up of a shape memory material as a constituent of the activation apparatus. Electrically conductive shape memory materials can be used in different ways in connection with the present invention. In a first variant, the same current flows through the electrically conductive component made up of the shape memory material, as also charges or discharges the galvanic cell to which the protective apparatus is assigned, which contains the activation apparatus, which contains the electrically conductive component made up of the shape memory material.

With an appropriate choice of materials, especially in the case of a suitable dimensioning of the temperature values at which the material assumes one of two possible shapes in each case, it can be achieved in this way with the aid of the electrically conductive component made up of a shape memory material that, when a certain value of the current which is flowing through the component is exceeded, the device is correspondingly heated and that the component interrupts the current as a consequence.

Various variants for realising the present invention are in turn possible within these variants. In a first variant, the shape memory material component can be brought back to its original shape with the aid of an elastic spring, as soon as it has cooled down again after turning off the current. In an implementation using two-way effect shape memory materials, it is also possible however, to effect the regression of the shape without using an elastic spring, solely with the aid of the memory effect of the material.

Taking account of these conditions, it is very simply possible for the person skilled in the art to produce protective apparatuses for galvanic cells on the basis of the present description with the aid of components made up of shape memory alloys or shape memory polymers, which in the case of an activation of the protective apparatus lead to a change of the interconnection by means of bridging, and which, depending on the circumstances and objectives of the relevant application of this bridging, also reverse the bridging again after the cessation of circumstances requiring the bridging, and therefore electrically reintegrates the galvanic cell into the battery assembly.

Which of these options are implemented in each case by the person skilled in the art depends on the relatively narrow circumstances of the application considered in each case. If the bridge was used to prevent a particularly critical situation, it will be appropriate in many cases to not reverse the bridging, even after the cessation of the circumstances requiring the bridging. On the other hand, there are applications in which the bridging was triggered by circumstances which are suited by their nature to reversing the bridging again after the cessation of these circumstances. An example of such a situation may be present, if a galvanic cell was exposed to too high a temperature due to external influences and therefore had to be bridged temporarily without this bridging needing to be long-term, perhaps because the heating of the galvanic cell would be an indication for an imminent destruction of this galvanic cell.

An activation apparatus with an electrically conductive component made up of a shape memory material, through which the current, using which the cell assigned thereto is charged or discharged, flows, will therefore be an advantageous embodiment of the present invention in cases in which the component made up of the shape-memory material, is included itself in the contacting of the galvanic cell. If, by contrast, a design is intended, in which the component made up of the shape memory material is not used for contacting the galvanic cell, then another embodiment of the invention, in which an electrically insulating component made up of a shape memory material is used, is suitable. In these cases it will often be advantageous if the component made up of the shape memory material, by means of the deformation thereof, performs the work which is required to displace electrical conductive contact elements on the galvanic cell or within an arrangement of galvanic cells in such a manner that the change according to the invention of the interconnection is effected, which enables a bridging of the galvanic cell and thus the removal thereof from the battery assembly.

When using an electrically conductive component made up of a shape memory material, yet another design variant of the invention is in addition possible, in which the current flows through this component, which current is controlled by a signal which is generated within and outside of the protective apparatus for controlling the activation apparatus. A signal of this type for the activation can in turn be generated by a sensor which measures a physical value which is indicative for the operating state of a galvanic cell which is assigned to the protective apparatus, because the activation apparatus includes the component with the shape memory material.

To limit inrush currents during the reintegration of galvanic cells removed from a cell assembly into the cell assembly, NTC resistors can advantageously be used to limit inrush currents. An NTC resistor of this type, which can also be used as a contact element in connection with galvanic cells according to the invention, is preferably cold before it is switched on; it therefore conducts poorly and reduces the inrush current. After switching on, it warms up by means of the current flow and loses its high initial resistance. Particularly advantageously, such NTC resistors can be used if they are short circuited following a short period, for example after a few milliseconds, with the aid of an electromechanical switch (relay), so that they can cool down. As a result, the service life of the NTC resistors is increased and as a further advantage, as the NTC resistors can cool down following the short circuit by means of the relay, an immediate recovery of the NTC resistor results, even in the case of short switch-off periods.

NTC resistors or so-called resistors with a negative temperature coefficient (“negative temperature coefficient thermistors”), which are also termed NTC thermistors, are electrically conductive materials which conduct electricity better at high temperatures than at low temperatures. Thus, the electrical resistance thereof decreases with increasing temperature. Therefore, one also speaks of a negative temperature coefficient.

Pure semiconductor materials and various other alloys with negative temperature coefficients show heat-conducting behaviour. Components for which the temperature-dependent behaviour specifically is utilised, are often metal oxides which are pressed, sintered and mixed with binders. The resistance of components of this type can be set in a wide range by means of the mixing ratio of various materials.

NTC resistors are often produced from a mixture of semiconducting metal oxides or from so-called compound semiconductors. These include in particular oxides of manganese, nickel, cobalt, iron, copper or also titanium.

So-called PTC resistors, which are also termed PTC thermistors show the opposite behaviour compared to NTC resistors. The abbreviation PTC here stands for the positive temperature coefficients of these materials. One is concerned here with current-conducting materials, which can better conduct the current at low temperatures than at high temperatures. Basically, although all metals have a positive temperature coefficient, in contrast with the PTC resistors meant here, the temperature coefficient of the usual metals is generally substantially smaller and behaves linearly for the most part. PTC resistors of this type can for example be used in connection with the here-described galvanic cells according to the invention to stabilise the temperature of a galvanic cell. Namely, if the temperature of an individual galvanic cell increases, then by means of suitable arrangement of a PTC resistor of this type, it can be achieved that the temperature thereof also increases and therefore the resistance of this PTC resistor component rises. As the conductivity thereof decreases with increasing temperature, the current loading of the correspondingly connected electrochemical energy store, that is to say of the galvanic cell, is reduced, which in many cases will lead to this galvanic cell cooling down.

Following the cooling down of the galvanic cell, a PTC resistor located in the vicinity thereof will also cool down, whereupon its conducting capability rises again. As a consequence, the current can rise again by means of this PTC resistor. PTC resistors can therefore be used in the context of the present invention to limit the current into a galvanic cell during charging or out of a galvanic cell during discharging and therefore to keep the temperature of this galvanic cell stable.

Further advantageous embodiments of protective apparatuses according to the invention can be realised by means of a clever combination of NTC resistors, PTC resistors and shape memory materials. In the case of a suitable design combination of NTC resistor or PTC resistor materials with shape memory materials, it can be achieved that not only the electrical conductivity of a contact element used for contacting a cell in a cell assembly, that is to say its electrical resistance, changes, but rather it can additionally be achieved that in the case of the achievement of certain temperatures or in the case of leaving certain temperature ranges, a shape change of the corresponding component takes place, which leads to a switching or to a change of the interconnection of the galvanic cells.

The following reference numbers were used in the figures for identifying the illustrated details:
201, 301, 801, 1001, 1101, 1201
Galvanic cell, battery cell
202, 302, 802, 1002, 1102, 1202
Galvanic cell, battery cell
203, 503, 603, 803, 1003, 1103, 1203
Electrode, diverter, diverter plate
204, 504, 604, 704, 1104
Electrode, diverter, diverter plate
205, 405, 805, 905, 1005, 1205
Contact rail, contact element
206, 406, 506, 606, 706, 806, 1106
Contact plate of an electrode
207, 407, 507, 607, 707, 807, 907, 1007, 1107, 1207
Contact plate of an electrode
208, 408, 508, 608, 708, 808, 908, 1008, 1108, 1208
Wave spring
209, 409, 509, 709, 1009
Contact rail, contact element
910, 1110, 1210
Bearing of the wave spring
911, 1011, 1111, 1211
Fuse wire
212, 1012, 1212
Contact rail, contact element
1013
Contact plate of an electrode
214, 1014
Contact plate of an electrode
1230
Predetermined breaking point of the fuse wire
390
Section from FIG. 3 illustrated in FIG. 4

The FIGS. 2, 3, 4, 8, 10 and 11 show exemplary embodiments of a battery made up of battery cells with protective apparatuses according to the invention. A battery of this type preferably consists of a plurality of protective apparatuses which are arranged between adjacent cells of the battery. In this case, a plurality of contact elements is provided for interconnecting a series connection and/or parallel connections of cells of the battery. A first part of these contact elements is arranged in a movable manner; a second part of these contact elements is arranged in an immovable manner. An activation of a protective apparatus of a first cell causes a movable first contact element, which is used before the activation for an electric series connection to an adjacent second cell, is moved in the case of activation of the protective apparatus and pressed against an immovable second contact element, as a result of which the first cell is bridged and therefore electrically removed from the series connection.

1-17. (canceled)

18. A protective apparatus for galvanic cells which are interconnected by contact elements to form a battery, the contact elements being connected to pole connections of the battery cells, wherein
the protective apparatus has an activation apparatus to activate the protective apparatus, and
the protective apparatus bridges a cell assigned to it by a change of interconnection when the protective apparatus is activated, the change in interconnection electrically removing the cell that is bridged from the battery assembly, and
wherein an activation apparatus in which a current flows through and heats a component made of a shape memory material, which changes the interconnection by means of a change in the shape of the component, as long as the temperature of the component is outside of a predefined temperature range.

19. The protective apparatus according to claim 18, wherein the component made up of a shape memory material is an electrically conductive component or an electrically insulating component.

20. The protective apparatus according to claim 19, wherein the current from a cell assigned to the protective apparatus is charged or discharged, or the current controlled by a signal which is generated within or outside of the protective apparatus for controlling the activation apparatus, flows through the electrically conductive component made up of a shape memory component.

21. The protective apparatus according to claim 18, comprising:
an energy store to store energy required to change the interconnection, the energy store providing the energy to change the interconnection in the case of an activation.

22. The protective apparatus according to claim 21, comprising a mechanical energy store.

23. The protective apparatus according to claim 18, wherein the protective apparatus is assigned to individual cells of a battery.

24. The protective apparatus according claim 18, comprising:
an activation apparatus to be activated by a signal generated outside of the protective apparatus and/or a signal generated inside the protective apparatus.

25. The protective apparatus according claim 18, comprising
an activation apparatus to be activated by a signal generated by at least one sensor which measures at least one physical value indicative of an operating state of a galvanic cell assigned to the protective apparatus.

26. The protective apparatus according to claim 24, wherein the activation apparatus is deactivated upon a subsequent cessation of prerequisites for its activation, and the protective apparatus reverses the bridging of the cell assigned thereto to reintegrate the cell into the battery assembly.

27. The protective apparatus according to claim 18, wherein the protective apparatus is configured to be arranged between pole connections of adjacent cells.

28. The protective apparatus according claim 18, comprising:
an activation apparatus including a fuse wire, which holds a wave spring that serves as energy store, in a tensioned state, the activation apparatus being activated by a current pulse which fuses the fuse wire, wherein the wave spring is relaxed and provides the energy required to change the interconnection in response to fusion of the fuse wire.

29. The protective apparatus according to claim 18, comprising an airtight housing.

30. The protective apparatus according to claim 29, wherein the airtight housing is filled with a protective gas.

31. A galvanic cell with a protective apparatus according to claim 17.

32. A battery with at least one galvanic cell according to claim 31.

33. A battery with a plurality of galvanic cells according to claim 30, wherein the battery includes
a plurality of protective apparatuses arranged between adjacent galvanic cells of the battery;
a plurality of contact elements to interconnect a series connection of galvanic cells of the battery, a first part of the plurality of contact elements being movable, a second part of the plurality of contact elements being immovable,
wherein an activation of a protective apparatus of a first galvanic cell causes a movable first contact element, which is used before the activation for an electric series connection to an adjacent second galvanic cell, is moved in the case of activation of the protective apparatus and pressed against an immovable second contact element to bridge the first galvanic cell and electrically remove the first galvanic cell from the series connection.
